(19) United States
(12) Patent Application Publication
(10) Pub. No.: US 2008/0172265 A1
(43) Pub. Date: Jul. 17, 2008

(54) SYSTEM AND METHOD FOR ENVIRONMENTAL UTILIZATION

(76) Inventors: W. Carey Crane, Middleburg, VA (US); B. Chandler Van Voorhis, The Plains, VA (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/623,858

(22) Filed: Jan. 17, 2007

(51) Int. Cl. G06Q 10/00

(52) U.S. Cl. 705/7

(57) ABSTRACT

A system and related method for managing of a geographic area, such as an area of land having at least one resource wherein direct and indirect revenue streams may be obtained is disclosed. The system allows for determination of the value of an area of land based on a selected utilization strategy that may specify a schedule for harvesting of any resources produced by the geographical area. A plurality of inputs is then retrieved, including at least one financial input and at least one biological input for the area of land. The value of one of retrieved inputs is then varied over a selected range of values for one or more time intervals. The development of at least one resource is predicted for the same one or more intervals. A variation in value for the area of land is then calculated for each of the one or more time intervals for each utilization strategy. Based on the calculated variations, the system then determines if a crossover point exists for changing the current utilization strategy that make such a change in utilization strategy favorable. In addition, a tree growth model may be applied to a single type of tree, a mixture of trees, or a planned layout of trees, such as a planned layout where one tree type serves as a growth aid for a second tree type.

### BACKGROUND

The increase in environmental awareness over the past decades is leading to new ways of generating value from land. Governmental programs and market exchanges for trading of environmental credits are among the revenue sources that an area of land can generate without harvesting a resource from the land. However, conventional methods for determining property values lack the flexibility to include the increasing number of revenue streams that can be realized for an area of land.

Due to the shortcomings of previous valuation methods, areas of land that should be economically used for environmentally friendly purposes are not being identified. Thus, some areas of land that could be used for reforestation are instead being used for purposes that are both environmentally and economically less advantageous. Additionally, even for areas of land that are dedicated to reforestation, it is often difficult to evaluate the relative merits of different utilization strategies for maintaining the land and harvesting resources. The benefit of an area of land should be reflected in its overall value. For example, such a benefit of an area of land may be reflected in a tree grown model that can be applied to a single type of tree, a mixture of trees, or a planned layout of trees, such as a planned layout where one tree type serves as a growth aid for a second tree type. In addition, direct and indirect revenue streams may also be generated by an area of land or areas of forestation where one type of tree is a growth aid to another type of tree.

What is needed is a system and method for determining current and future values for an area of land that is flexible enough to include various types of revenue sources. The system and method should allow for investigation of different strategies for utilizing an area of land under a selected group of constraints.

### SUMMARY

In an embodiment, for example a method is provided for managing an area of land having tree resources. The method may include selecting a utilization strategy for an area of land having one or more tree resources. This utilization strategy can be a new strategy for the area of land, or the utilization strategy can reflect the current conditions or uses of the area of land. A plurality of inputs are retrieved, including at least one financial input and at least one biological input for the area of land. Based on these retrieved inputs, the development of the one or more tree resources on the area of land may be calculated for a plurality of time intervals. The calculated development of the one or more tree resources can then be used to forecast the value of the area of land for the plurality of time intervals. Based on the forecast values, a harvesting schedule may be selected for the one or more tree resources.

In another embodiment, a method for managing an area of land is provided. The method begins by providing a plurality of utilization strategies for an area of land having at least one resource. Note that at least one of the provided utilization strategies should correspond to the current utilization strategy for the area of land. A plurality of inputs is then retrieved, including at least one financial input and at least one biological input for the area of land. The value of one of the retrieved financial inputs is then varied over a selected range of values for one or more time intervals. The development of the at least one resource is predicted for the same one or more time intervals. A variation in value for the area of land is then calculated for each of the one or more time intervals for each utilization strategy, the calculation being based on the predicted development of the at least one resource and the variation in value being based on the at least one varied financial input. The calculated variations are then used to determine if a crossover point exists for changing from the current utilization strategy to a second utilization strategy.

In still another embodiment, a system for managing an area of land is provided. The system includes a data retrieval module for retrieving a plurality of inputs with the plurality of inputs including at least one financial input and at least one biological input. The system also includes an agricultural production module for predicting the development of at least one resource for a plurality of time intervals. The system further includes a financial module for forecasting the value of the area of land for the plurality of time intervals based on the predicted development of the at least one resource. Additionally, the system includes a deliverable generation module for providing information regarding predicted development of resources, forecasts of revenue streams, and utilization strategies for an area of land.

### BRIEF DESCRIPTION OF THE DRAWINGS

FIG. 1 schematically shows a system for managing an area of land;

FIG. 2 provides a flow chart illustrating a method of managing an area of land;

FIG. 3 provides a flow chart illustrating another method of managing an area of land;

FIG. 4 illustrates an interplanting scheme; and

FIG. 5 illustrates another example of an interplanting scheme.

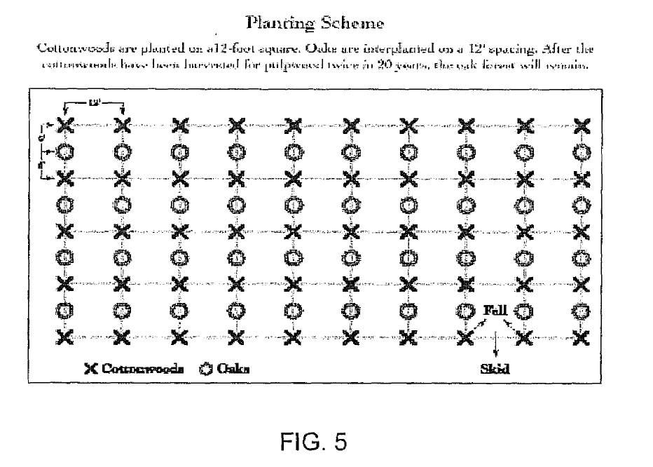

### DETAILED DESCRIPTION

### I. Overview

In an embodiment, a system and method is provided for managing the use of a geographic area, such as an area of land. The system and method allows a large number of inputs, corresponding to both current and future valuations, to be combined in order to determine a preferred utilization strategy for a geographic area. In some embodiments, the preferred utilization strategy can correspond to a highest overall revenue for the area of land. In other embodiments, the preferred utilization strategy can correspond to the highest overall revenue for a selected group of revenue streams associated with the area of land. In still another embodiment, the system and method can be used to determine a crossover point corresponding to market conditions that make a change in utilization strategy favorable.

In various embodiments, the system and method provide a number of advantages relative to conventional techniques for evaluating land use. For example, the system and method allow a wide variety of income streams to be included during evaluation. The income streams may include government credits for maintaining an environmentally desirable use in a geographic area. The income streams may also include income based on separable properties of the geographic area, such as the carbon consumption properties of a wooded plot of land. Still other income streams can include future sale rights for renewable resources in a geographic area, such as trees, based on growth models for the renewable resource. Additionally, various types of appreciation of the underlying geographic area can also be accounted for.

In yet another embodiment, the system and method allow updates and changes to be made once a utilization strategy has been selected for a geographic area. For example, an agricultural model for how an area of land will develop over time can be used in combination with financial models to evaluate schedules for harvesting of renewable resources on the area of land. In such an embodiment, the system and method includes predictive inputs for both expected prices of goods, such as lumber or wood pulp, as well as expected changes to renewable resources, such as growth rates for trees. This allows comparisons to be made between a current value for harvesting a resource and a future value and related values of alternative tree assets. Additionally, the updates and changes to the utilization strategy can be provided within the constraints of a long-term utilization strategy. Such constraints can include, for example, minimum and maximum harvest rates for thinning the tree population on an area of land.

In an embodiment, the system and method for determining the valuation of a geographic area may be based on several interacting components. The components can include: 1) an Agricultural Production Model; 2) measured biological inputs related to the geographic area; 3) a Cash Flow Financial Model; 4) Financial Inputs such as market analysis data or values for environmental assets; 5) an Investor Deliverables module; and 6) a Landowner Deliverables module.

### II. Agricultural Production Model

In an embodiment, an Agricultural Production Model (APM) provides predictions of how the agricultural resources and associated characteristics of a geographic area will develop over time. To model the development of the geographic area, a utilization strategy for the area is used as a starting point. For example, in a plot of land having tree resources, the layout and type of trees on the plot can serve as a starting point. The current and expected future development of resources in the geographic area are then evaluated based on a wide variety of inputs. In a tree production example, the inputs can include the average soil index for the plot of land, the soil index for the past 10 years, the historical planting success (survival) rate for the plot of land, the growth history of the trees (including any delays in planting relative to an expected schedule), weather data during the growth history, and any damage or infestations in the trees on the plot of land. In another embodiment, the inputs can include forest canopy tracking, tree growth rates, and tree diameters.

These various types of data can be used in developing a tree growth model to predict expected growth for the trees during a time period. Additionally, predicted growth can be further refined by comparing the growth history of the trees with previous predictions of tree growth. The tree growth model can be applied to a single type of tree, a mixture of trees, or a planned layout of trees, such as a planned layout where one tree type serves as a growth aid for a second tree type.

Additional measured values can correspond to potential revenue streams from the area of land. One source of revenue is from the sale of wood products harvested due to thinning of the trees. Such wood products can include saw timber, wood pulp, and biomass. Another revenue source is the value of any carbon sequestered by the trees during growth. Yet another revenue source is nutrient accumulation or depletion due to the tree production.

The measured current status and forecasted development of a renewable resource, such as trees, is then used as input data for determining current values of the renewable resource if harvested for a specific purpose, and for predicting future values based on both the expected growth of the renewable resource as well as expected market conditions.

### III. Utilization Strategies

In an embodiment, a utilization strategy may represent a planned use for a geographic area. A variety of components are included in such a utilization strategy. The utilization strategy specifies the overall intended use of the geographic area, such as forest, prairie, wetland, kelp bed, or another type of environment. Additionally, the utilization strategy may specify a schedule for harvesting of any resources produced by the geographic area. For example, the utilization strategy for a forest area can specify a harvesting schedule for the trees in the area of land.

One aspect of a harvesting schedule is a maintenance or thinning schedule, where a portion of the resource is harvested to maintain the overall health of the geographic area. Another aspect of a harvesting schedule is based on optimizing the revenue of the geographic area. When the current harvest value of a resource is greater than the predicted future value, the amount of current harvest can be increased. Similarly, harvesting of a resource can be delayed if the expected future value of the resource will be greater.

A utilization strategy can also place constraints on the harvest schedule. In one embodiment, the utilization strategy may be designed to maintain the overall intended use. For example, a utilization strategy for a forest area could require a minimum number of trees to remain in the geographic area regardless of market conditions. In such an embodiment, the utilization strategy allows an intended use for the geographic area to be maintained regardless of other market conditions or costs.

A utilization strategy for an area of land may change over time. For example, one may modify the harvest schedule for the area of land due to economic considerations. Alternatively, the type of tree and/or selection of tree growth as the intended use may change based on the progress after a particular time interval.

In one embodiment, a system and method according can be used to select a utilization strategy for an area of land. In this particular embodiment, a utilization strategy involving a forest intended use will be analyzed.

As an initial step, a type of utilization strategy, including an intended use, is selected as a framework for determining the future value under the utilization strategy. In this example, a forest type intended use is selected. A planting plan may also specified. The planting plan can include just a single type of tree, such as pecan, oak, another hardwood tree, or another type of tree. Alternatively, the planting plan can include two or more types of trees. In such a plan, one tree can be a more desirable tree type, such as a hardwood tree, while the second tree may be a complementary tree, such as a nurse tree that will facilitate the growth of the hardwood tree. An example of planting plan with two or more tree types is one involving oak trees and cottonwood trees. A pattern of cottonwood trees can be initially planted. After two years, a pattern of oak trees may be planted between the cottonwood trees. The cottonwood trees aid the growth of young oak trees. After a period of time, such as 20 years, the cottonwood trees can be harvested leaving behind a forest of oak trees on the area of land.

A harvesting schedule can also be specified for the area of land. The harvesting schedule specifies when one or more trees (or other resources) should be harvested. As described above, the harvesting schedule can include a thinning rate to maintain the health of the area of land as well as a specified time for harvesting a portion of the trees to realize revenue. Other factors can be included in the harvest schedule as well.

### IV. Biological Inputs

After selecting the framework utilization strategy, including the intended use, planting plan, and harvest schedule, various inputs are obtained or received. The inputs may be related to how the resources will develop over time, the current and future value of resources, and other values related to forecasting the value of the area of land under the utilization strategy. Note that some input values may be useful for more than one purpose.

One type of input that can be obtained is an input for use in preparing a forecast for the growth or development of the area of the land over time. To predict the development of resources in a hardwood forest, a variety of inputs can be helpful in preparing a forecast. For example, inputs related to the current conditions of the trees can be used to help develop the starting point for the forecast. This could include inputs for the diameter of the trees; the current value and historical values for the soil index (a measure of the quality of the soil); forest canopy tracking, such as aerial imaging of the trees on the area of land; any delays or changes to the planting schedule relative to the expected plan; infestation reports for insect activity near the trees; and other natural damage reports regarding damage to the trees.

Another group of forecasting inputs can relate to past performance of an area of land or past performance of the forecasting model. For example, such inputs can include the historical value for planting success (the number of trees that survive to maturity) and previous growth predictions compared to measured tree growth during a period of time.

The forecasting inputs can then be used to project the development of the resources on the area of land. In this example, the trees represent the primary resource being developed. The development of the trees over various time intervals can then be predicted, as described above.

### V. Example of Tree Growth Model

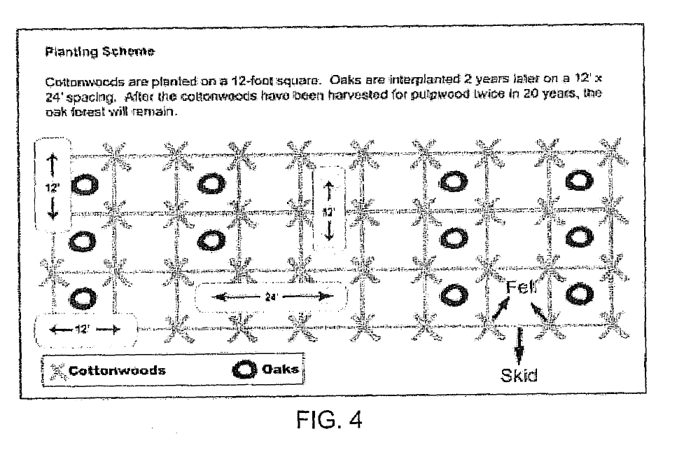

One tree growth model may measure the growth of cottonwood-hardwood interplanting over a 70-year period in the Mississippi Delta region. The tree growth model is flexible in order to handle different interplanting schemes. Two types of interplanting schemes suitable for use with the model are shown in FIGS. 4 (scheme 302/151) and 5 (scheme 302/302). The tree growth model is designed to measure three forests: the cottonwood forest, the hardwood forest and the native hardwood forest.

Data on the hardwood model is based upon actual growth of native stands, over time, on Water oak, Willow oak and Nuttall oak on clay soils in the Lower Mississippi Alluvial Valley (LMAV), typical of what is going into the United States Department of Agriculture's Wetland Reserve Program (WRP) and Conservation Reserve Program (CRP) at the present time. It was assumed that these were average sites for the LMAV soils. As data on the hardwood model from age one to nine are very weak it is recommended that volumes for these age groups be ignored and thus begin calculations at age ten. To achieve the projected yield on the hardwood it is recommended that pre- and post-emergent herbicide treatments are applied to reduce the competing vegetation.

Cottonwood growth and yield is based upon a cottonwood model that was developed in the LMAV and was derived from actual measurements of cottonwood plantations. For the cottonwood model it is recommended that calculations begin no earlier than age three. To achieve the projected yield on the cottonwood, it is recommended that the normally accepted silvacultural practices are followed. As a rule of thumb the Site Index (SI) for cottonwood on the heavier soils is less than 75 sq. ft., on the medium soils 75 sq. ft. to 90 sq. ft. and over 90 sq. ft. on the lighter soils.

The harvesting schedule is driven by Site Index (SI) and Basal Area (BA). SI on cottonwood is based on height at age 10 while SI on hardwood is based on height at 50 years. It was assumed that the average SI for the hardwood model is 95 sq. ft. SI on the heavier soils is about 85 and about 105 on the lighter soils. The percentage change in hardwood SI will have a like percentage change in volume.

In an embodiment, for the cottonwood side of the model the BA should not be allowed to exceed 85 sq ft., preferably 75 sq. ft. and most preferably 70 sq. ft. before thinning. In another embodiment, the cottonwood portion of the stand should not be thinned below 30 sq. ft. of BA, preferably not below 35 sq. ft of BA, and most preferably not below 40 sq. ft. of BA. In an embodiment, before thinning the hardwood BA should be 115 sq. ft. or less, preferably 105 sq. ft. or less, or most preferably 95 sq. ft. or less. In another embodiment, the hardwood BA should not be thinned below 65 sq. ft. of BA, preferably 55 sq. ft., and most preferably 45 sq. ft.

Each particular area of land may be evaluated separately based upon topography, soils, and hydrology. By manipulating Site Index and Basal Area the harvesting schedule can be adapted to fit growth and yield goals for that particular site.

Preferably, the first thinning in the cottonwood can be a mechanical thinning based on a predetermined pattern, such as every other row, every third row, or every other tree. The trees are relatively small and it is usually not cost effective to mark individual trees for the first thinning. It is also easier and less expensive to log. Depending upon stand and market conditions later thinnings may be either mechanical or individual tree selection.

Recommended silvacultural practices for use in stands that are managed according to the invention include practices for site preparation, planting practices and schedules, pre-emergence herbicide treatments, mechanical cultivation and post-herbicide treatments, and pesticide treatments.

In one embodiment, site preparation occurs in September or October. First, an area of land can be disked lightly to level the land. A first set of trenches, in the form of rows, is then marked off to achieve a 12-foot spacing. Rows of subsoil trenches are then set up 20 inches deep at 12-foot spacings, with the subsoil rows oriented perpendicular to the first set of rows. Optionally, fertilizer can be applied in conjunction with subsoiling. The trenches are then allowed to be filled with silt as well as 4 inches of water, such as water from rainfall.

In an embodiment, planting for a site can occur during December, January, and/or February. During planting, planters can walk the marking trench to plant cuttings at the intersections with the subsoil trench. Preferably, 18-inch cuttings are used, and hand planted a minimum of 14 inches deep with vegetative buds upward. In one embodiment, the planting stock used can be genetically improved stock with a minimum diameter of 0.25 inches and a maximum diameter of 1.5 inches.

In an embodiment, a pre-emergence herbicide treatment can be used during January or February. In such an embodiment, herbicide can be sprayed in a 3-foot band down the center of a planted row of dormant cuttings. One example of a suitable herbicide is 80 oz./ac.+Gramoxone 24 oz./ac.+80-20 non-ionic surfactant 32 oz./100 gal. of water.

After planting, mechanical cultivation and/or post-herbicide treatments can be used during the period from April to August. For example, the space between rows can be disked and cultivate as closely as possible to remove an vegetation that might compete with the plantings. Specific examples of potential post-herbicide treatments include control of Johnson grass by spraying a three foot band (over the top of the growing trees) of Fusilade or similar herbicide at labeled rate+non-ionic 80-20 surfactant; or control of broadleaf vegetation by spraying a three foot band of herbicide over the top of the growing trees at 40 oz./ac.+80-20 non-ionic surfactant. Additionally, during any period pesticide treatments can be applied as needed, such as pesticides for control of Cottonwood Leaf Beetle. A suitable treatment is Sevin XLR 24 oz./ac.

After two years of growth of the Cottonwood cuttings, hardwood trees can be planted. Mechanical cultivation may be carried out during June or July by disking once or twice, as needed. Hardwoods suitable to the site can then be planted at a spacing of 12 feet by 24 feet.

### VI. Market Inputs

In an embodiment, a second set of inputs is related to market input or market valuations of various parts of the geographic area. The market inputs can include market valuations for any renewable resources, market valuations for environmental assets, and cash flows derived from regulatory restrictions. The market valuations can include both current valuations and expected future valuations. Additionally, the market valuations can represent both income streams generated by the geographic area, as well as appreciation of the geographic area itself.

In an example related to tree production, the market valuations for renewable resources can correspond to market prices for pulp and paper pricing, saw timber pricing, biomass pricing, and/or other prices for wood and wood products. The environmental asset valuations can correspond to carbon sequestration credits (such as those traded on a climate exchange), changes in nutrient values in the plot of land, and/or the value of auxiliary use rights (such as hunting or fishing rights). Regulatory cash flows can represent government issued credits based on the utilization strategy for the geographic area, such as government credits for reforestation of land.

Market valuations for a resource can be determined in a variety of ways. For example, commodity markets already exist for resources such as pulp and saw wood timber. Resources such as biomass and/or carbon could be evaluated using another commodity as a proxy, such as coal. Carbon can also be valued based on trading values in current European exchanges.

The current and future valuations can then be used in combination with the resource development (i.e., tree growth) forecast to project the future value of the area of land at various time intervals. At each interval, the forecast of resource development will provide a size, quality, and other features regarding the resource. In this example, the forecast will provide a description of the trees present on the area of land. This forecast information can be used to project the value of a variety of direct and indirect revenue streams for the area of land. To calculate this projection, the forecast information can be combined with inputs relating to the current and future value of various products that can be formed from the harvested resource or area of land.

For example, there are direct and indirect revenue streams that are created by an area of land and areas of forestation where one type of tree is a growth aid to another type of tree. An area of land may have different types of differentiating resources. In addition, there are multiple ways for differentiating the values contained in an area of land. Direct revenue streams represent revenue streams based on harvesting of the resource. In this example, direct revenue streams correspond to revenue from harvesting and processing of wood during a specified time interval. For example, current and future values can be projected for harvesting a portion of the trees on the area of land, as well as possibly converting the trees to a product such as wood pulp or saw timber. To form this projection, the forecast for the amount of timber available for harvest at a given time interval is combined with the projected price for live timber versus a timber product.

In contrast, indirect revenue streams represent sources of revenue other than those generated by harvesting a resource. The indirect revenue streams can include both commercial revenue streams as well as income due to governmental programs. Once again, the forecast for the amount of timber would be used to determine the impact on the indirect revenue stream. For example, in a wooded area of land, indirect revenue streams could include the value of hunting rights in the area or revenue due to carbon sequestration by the trees as the trees grow. Note that this latter source of revenue could represent a current/expected valuation on a commercial carbon exchange, or a government regulated payment. Other types of indirect revenue streams are also possible, such as government regulated payments for habitat preservation.

Still another type of indirect revenue stream is the ecological dividend produced by maintaining a utilization strategy for an area of land. For example, if an area of land is planted with cottonwood trees, the trees will over time improve the quality of the soil on the land. More generally, the planting of cottonwood trees will lead to development of an ecosystem surrounding the cottonwood trees. This can lead to improvements in water, air and soil quality for the area of land.

In addition to the direct and indirect revenue streams, a value can also be attached to any “non-revenue” characteristics of the land that should be considered. For example, if an area of land is used as part of a larger area that must meet certain criteria to qualify for a government regulated payment, a proportional amount of the payment could be assigned to the area of land. Alternatively, a particular revenue stream might not be realized until a future date. In another example, an environmental or conservation aspect of an area of land may only have value if it is able to be used as an offset against another asset held by the owner of the land. For example, consider an owner for the area of land who also owns a carbon releasing facility, such as a power plant. The carbon sequestration by trees may have additional value based on regulations requiring a payment based on carbon release unless the carbon is sequestered. Still another example would be the presence of a river on an area of land. Although the river may not have a direct value, the presence of the river could potentially reduce the costs associated with harvesting timber. This benefit of an area of land should be reflected in its overall value.

### VII. Financial Model

In an embodiment, based on the total number of revenue streams available, the current valuation of the area of land can be calculated. The future valuation of the land at various time intervals may also be determined. These current and projected valuations can be compared among themselves and with valuations based on other utilization strategies. In an embodiment, the utilization strategy with the highest current or future valuation can be selected for use. In another embodiment, the future valuation may be discounted in a conventional manner to reflect the present value based on the future valuation.

In addition to selecting an initial utilization strategy and/or a current utilization strategy, in another embodiment the system and method can be used to determine one or more conditions that would favor a change in utilization strategy. In such an embodiment, an area of land has a current utilization strategy, which would include a harvest schedule. The system and method could be used to determine if the utilization strategy should change based on fluctuations in the value of an input. In a forest example, a change in the utilization strategy could be investigated based on the price of saw lumber, a change in the value of carbon sequestered by the area of land, or another variable. The value at which another utilization strategy becomes more valuable than the current utilization strategy can be referred to as a crossover point.

### VIII. Investor and Landowner Deliverable Modules

In various embodiments, the revenue streams and valuations for an area of land can be reported to landowners and investors for an area of land. The landowner should receive updates regarding the current and future values of the area of land under the selected utilization strategy. The deliverable to the landowner could also include details about one or more of the revenue streams. The deliverable could further include a comparison between the value of the land under the current utilization strategy as compared to alternative strategies, such as under a different harvesting schedule or a different intended use. The investor deliverables can be similar to the landowner deliverable, or an investor deliverable can be targeted to report on only the revenue streams owned by the investor.

### IX. Exemplary Embodiments

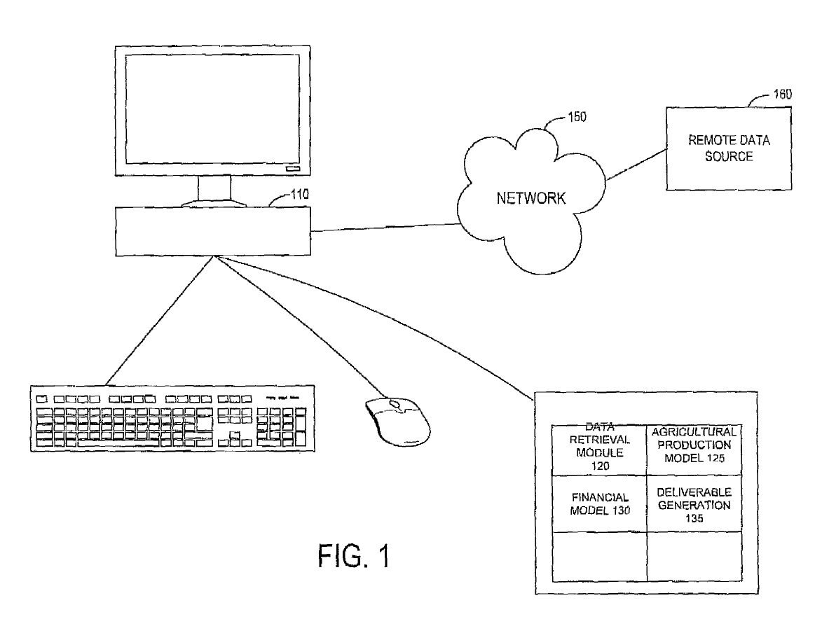

FIG. 1 depicts a system for selecting a utilization strategy for an area of land according to one embodiment. In the embodiment shown in FIG. 1, a computer 110 is connected to a network 150. The computer can be any conventional type of computer, such as a server or a personal computer. The computer may be configured to enable a data retrieval service 120 for retrieving data from one or more remote data sources 160. A remote data source may be a financial information source that provides current and future costs for resources, a source that provides agricultural input information, or a source of other information that is useful for an embodiment of the invention. The computer may also be configured to enable an agricultural production model 125 for forecasting the growth of trees or other agricultural resources on an area of land. The computer may be further configured to enable a financial model 130 for evaluating utilization strategies for an area of land and computing crossover points for comparison of various utilization strategies. Finally, the computer may be configured to enable a deliverable service 135 for providing information to landowners and other investors.

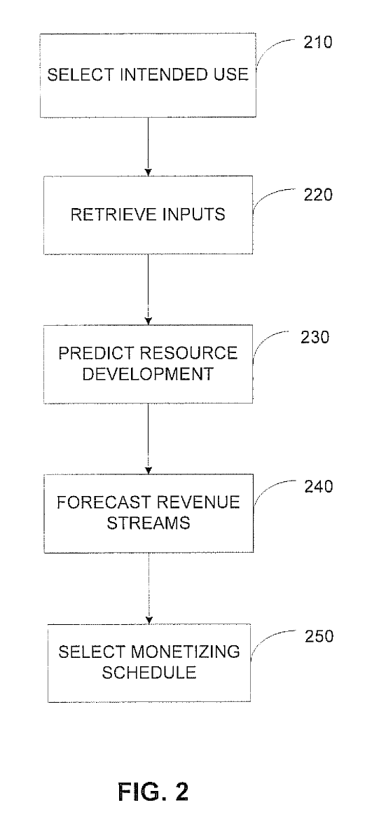

FIG. 2 depicts a flow chart for a method of selecting a utilization strategy according to one embodiment. In the embodiment shown in FIG. 2, an intended use for an area of land is selected 210. A plurality of inputs related to selecting the utilization strategy is retrieved 220. The retrieved inputs may include at least one financial input and at least one biological input. The development of at least one resource associated with the area of land is then predicted 230 for a plurality of time intervals. Based on this prediction, one or more revenue streams for the area of land are forecast 240. The revenue streams may be forecast for each of the plurality of time intervals. The forecasts are based at least in part on the predicted development of the resource. The forecasts can then be used for selecting 250 a monetizing schedule for the at least one resource. The combination of an intended use and the harvesting schedule can be combined with a planting plan to form a utilization strategy for the area of land.

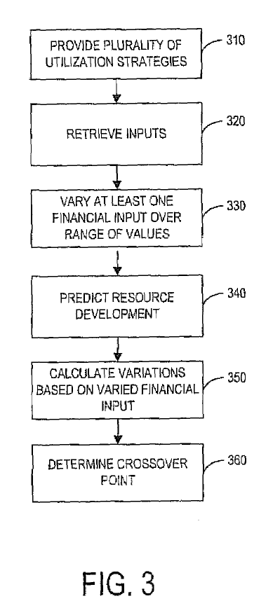

FIG. 3 depicts a flow chart for a method of determining a crossover point according to one embodiment. In the embodiment shown in FIG. 3, the method begins by providing 310 a plurality of utilization strategies for an area of land having at least one resource. At least one of the utilization strategies may correspond to a current utilization strategy for the area of land. A plurality of inputs is retrieved 320. The plurality of inputs preferably include at least one financial input and at least one biological input. At least one of the retrieved financial inputs is varied 330 over a range of values. The inputs are first used to predict 340 the development of the at least one resource for a plurality of time intervals. Based on this prediction, variations in value are calculated 350 for one or more revenue streams. A variation may be calculated for each of the plurality of time intervals under each utilization strategy. The variation is calculated based on the predicted development of the at least one resource as well as the variation in the at least one varied financial input. Finally, a crossover point is determined 360 based on the calculated variations. The crossover point corresponds to the value of the varied input where the preferred utilization strategy changes from the current utilization strategy to a different utilization strategy. The different utilization strategy may differ based on the harvesting schedule, the type of intended use for the land, or another aspect of the utilization strategy.

### X. Valuation Example

In an embodiment, The APM is made up of four main sources of data: 1) projected data (biological and financial); 2) actual data; 3) market data; and 4) land and project data. In such an embodiment, the first series of analysis the APM will undergo is analyzing how our projected growth and yield data of the forest is tracking with the actual data. The actual data will be gathered by on the ground foresters as well as aerial data. Inputs such as rainfall may be tracked to see what variables might be driving an increase/decrease of actual data vs. the projected data.

The second series of analysis the APM will undergo is optimizing the layers of assets that reside in a forest based on market data. The APM may track at least two main values—timber values and carbon values. Timber income is realized when a thinning of the forest occurs, while carbon income occurs as the forest grows in volume. Optimizing timber cut down versus carbon standing represents a tension point that the APM can focus on. Since a tree is 50% carbon, the price of spread between carbon and timber thinning must be greater than 2-1 to increase the carbon stock (and decrease the thinning stock). For example, if the price for a ton of pulp fetches $6 in the market, but the price of carbon tops $13, then it would be prudent to consider changing the allocations of carbon-timber in favor of more carbon in order to capture the extra $1 per ton.

Another tension point that the APM can manage is within timber. Currently the chief value of timber in the early years of tree life is pulpwood. However, an emerging market for biomass is taking place. So tracking the correlations between pulpwood prices and biomass pricing is essential in understanding whether the thinned timber is best marketed as pulp or biomass. The value of pulp wood can be readily determined, as markets for pulp wood already exist. Determining a biomass value, however, is more involved in that the pricing of biomass is calculated in terms of its energy output. For example, the price for biomass is sometimes expressed in $x per million BTUs.

Building on the previous example where the price of pulp is $6 per ton, consider an example where the price of biomass is $1 per mmBTU. At this price, pulp and biomass have similar values. In a further example, over time the price of pulp may remain flat at $6 per ton while the price of energy (biomass) increases to $2 per mmBTU. In this scenario, a 2-1 spread between biomass and pulp has developed. We call this spread a “bark spread.” This increased spread means that the timber carbon spread has changed as well. In the original example, carbon price had to be greater than two times the value of timber for the APM to recommend downgrading the amount of timber available for the market. Now, due to the increased value of biomass, the carbon price must be 4 times the value of the timber. If carbon fails to be greater than four times the value, the allocations stay the same. If carbon is greater than four times the value then a recommendation is made to change the allocations to capture this price arbitrage between carbon and biomass.

The third series of analysis that the APM can track is land/project data, in order to take advantage of the historical record of what management techniques worked on what soil type. Tracking land/project data will allow the APM to continue to refine its model as data becomes available.

The principles and modes of operation of this invention have been described above with reference to various embodiments. As understood by those of skill in the art, the overall invention, as defined by the claims, encompasses other preferred embodiments not specifically enumerated herein.

What is claimed is:

1. A method for managing an area of land having tree resources, comprising:
selecting a utilization strategy for an area of land having one or more tree resources;
retrieving a plurality of inputs, the plurality of inputs including at least one financial input and at least one biological input;
calculating the development of the one or more tree resources for a plurality of time intervals;
forecasting the value of the area of land for the plurality of time intervals based on the calculated development of the one or more tree resources; and
selecting a harvesting schedule for the one or more tree resources based on the forecast values.

2. The method of claim 1, wherein the one or more tree resources comprise a hardwood tree and a complementary tree.

3. The method of claim 1, wherein the at least one biological input is selected from the group consisting of a soil quality input, a rainfall input, or a tree size input.

4. The method of claim 1, wherein forecasting the value of the area of land comprises forecasting a value for at least one direct revenue stream, at least one indirect revenue stream, and at least one non-revenue characteristic.

5. The method of claim 1, wherein the harvesting schedule is constrained by the selected utilization strategy.

6. A method for managing an area of land, comprising:
providing a plurality of utilization strategies for an area of land having at least one resource, at least one of the utilization strategies corresponding to a current utilization strategy for the area of land;
retrieving a plurality of inputs, the plurality of inputs including at least one financial input and at least one biological input;
varying at least one financial input over a selected range of values for one or more time intervals;
predicting the development of the at least one resource for the one or more time intervals;
calculating a variation in value for the area of land for each of the one or more time intervals for each utilization strategy, the calculation being based on the predicted development of the at least one resource and the variation in value being based on the at least one varied financial input; and
determining a crossover point for changing from the current utilization strategy to a second utilization strategy based on the calculated variations.

7. The method of claim 6, wherein the at least one resource includes one or more tree resources.

8. The method of claim 6, wherein the one or more tree resources comprise a hardwood tree and a complementary tree.

9. The method of claim 6, wherein the at least one biological input is selected from the group consisting of a soil quality input, a rainfall input, or a tree size input.

10. The method of claim 6, wherein forecasting the value of the area of land comprises forecasting a value for at least one direct revenue stream and at least one indirect revenue stream.

11. The method of claim 10, wherein forecasting the value of the area of land further comprises forecasting a value for at least one non-revenue characteristic.

12. The method of claim 6, further comprising selecting a harvesting schedule for the area of land for each selected utilization strategy, wherein the harvesting schedule being constrained by the corresponding utilization strategy.

13. A system for managing resources on an area of land, comprising:
a data retrieval module for retrieving a plurality of inputs, the plurality of inputs including at least one financial input and at least one biological input;
an agricultural production module for predicting the development of at least one resource for a plurality of time intervals;
a financial module for forecasting the value of the area of land for the plurality of time intervals based on the predicted development of the at least one resource; and
a deliverable generation module for providing information regarding predicted development of resources, forecasts of revenue streams, and utilization strategies for an area of land.

14. The method of claim 13, wherein the agricultural production module is a tree development module.

15. The method of claim 14, wherein the at least one biological input is selected from the group consisting of a soil quality input, a rainfall input, or a tree size input.

16. The method of claim 13, wherein the financial module comprises modules for calculating direct revenue streams, indirect revenue streams, and non-revenue characteristics of the area of land.
